(19) United States
(12) Patent Application Publication
(10) Pub. No.: US 2026/0268534 A1
(43) Pub. Date: Sep. 10, 2026

(54) DATA PROCESSING DEVICE, DATA PROCESSING METHOD, AND COMPUTER-READABLE STORAGE MEDIUM

(71) Applicant: SOFTBANK GROUP CORP., Tokyo (JP)

(72) Inventor: Yuya KOINAGAKI, Tokyo (JP)

(73) Assignee: SOFTBANK GROUP CORP., Tokyo (JP)

(21) Appl. No.: 19/553,494

(22) Filed: Mar. 2, 2026

(30) Foreign Application Priority Data
Mar. 4, 2025 (JP) 2025-033992

(51) Int. Cl. G06T 11/00

(52) U.S. Cl. CPC G06T 11/00

(57) ABSTRACT

In some examples, a disclosed data processing device includes a processor that is configured to: derive an emotion parameter representing an emotion of a character drawn in a material; generate a dialogue on the basis of a story according to a subject; and generate comic data by placing the dialogue and the character in each panel of a panel layout by using a generation model on the basis of the emotion parameter.

### CROSS-REFERENCE TO RELATED APPLICATION

This application is based on and claims priority under 35 USC 119 from Japanese Patent Application No. 2025-033992 filed on Mar. 4, 2025, which is incorporated by reference herein in its entirety.

### TECHNICAL FIELD

The technology of the present disclosure relates to a data processing device, a data processing method, and a computer-readable storage medium.

### BACKGROUND

Japanese Patent Application Laid-Open (JP-A) No. 2015-1748 describes a technology in which, in a case in which learning is determined to be insufficient on the basis of learning situation data of a learner, an email for promoting learning is transmitted according to a past learning situation.

In the case of performing learning, awareness raising, and the like, there is room for ingenuity in content provided to the recipient in order to deepen understanding of the subject by the recipient.

### SUMMARY

A data processing device according to the technology of the disclosure includes: a derivation unit that derives an emotion parameter representing an emotion of a character drawn in a material; and a generation unit that generates dialogue on the basis of a story according to a subject, and generates comic data by placing the dialogue and the character in each panel of a panel layout by using a generation model on the basis of the emotion parameter.

A data processing method of the technology of the disclosure causes a computer to execute processing of: deriving an emotion parameter representing an emotion of a character drawn in a material; generating dialogue on the basis of a story according to a subject; and generating comic data by placing the dialogue and the character in each panel of a panel layout by using a generation model on the basis of the emotion parameter.

A program stored on a computer-readable storage medium according to the technology of the disclosure causes a computer to execute processing of: deriving an emotion parameter representing an emotion of a character drawn in a material; generating dialogue on the basis of a story according to a subject; and generating comic data by placing the dialogue and the character in each panel of a panel layout by using a generation model on the basis of the emotion parameter.

### BRIEF DESCRIPTION OF THE DRAWINGS

FIG. 1 is a block diagram illustrating an example of a configuration of a data processing system;

FIG. 2 is a block diagram illustrating an example of main functions of the data processing device;

FIG. 3 is a block diagram illustrating an example of a functional configuration of a specific processing unit of the data processing device;

FIG. 4A is an example of a prompt and an output in a case of deriving an emotion parameter from a material;

FIG. 4B is an example of a prompt and an output in a case of deriving the emotion parameter from the material;

FIG. 4C is an example of a prompt and an output in a case of deriving the emotion parameter from the material;

FIG. 5A is an example of a prompt and an output in a case of deriving an emotion parameter from a material;

FIG. 5B is an example of a prompt and an output in a case of deriving the emotion parameter from the material;

FIG. 5C is an example of a prompt and an output in a case of deriving the emotion parameter from the material;

FIG. 6 is an example of a prompt and an output;

FIG. 7 is an example of a panel layout;

FIG. 8 is a diagram for explaining an example of an aspect in which dialogue is placed in a panel;

FIG. 9 is a diagram for explaining an example of an aspect in which a character is placed in a panel in which dialogue is placed;

FIG. 10 is a flowchart illustrating an example of learning content generation processing;

FIG. 11 is a flowchart illustrating an example of emotion parameter derivation processing; and

FIG. 12 is a flowchart illustrating an example of comic data generation processing.

### DETAILED DESCRIPTION

Hereinafter, embodiments of a data processing device, a data processing method, and a program according to the technology of the disclosure will be described with reference to the accompanying drawings.

First, words used in the following description will be described.

In the following embodiments, a processor (hereinafter, simply referred to as a “processor”) denoted by a reference numeral may be one arithmetic device or a combination of a plurality of arithmetic devices. In addition, the processor may be one type of arithmetic device or a combination of a plurality of types of arithmetic devices. Examples of the arithmetic device include a central processing unit (CPU), a graphics processing unit (GPU), a general-purpose computing on graphics processing units (GPGPU), an accelerated processing unit (APU), and the like.

In the following embodiments, a random access memory (RAM) denoted by a reference numeral is a memory in which information is temporarily stored, and is used as a work memory by a processor.

In the following embodiments, a storage denoted by a reference numeral is one or more nonvolatile storage devices that store various programs, various parameters, and the like. Examples of the nonvolatile storage device include a flash memory (solid state drive (SSD)), a magnetic disk (for example, a hard disk), and a magnetic tape.

In the following embodiments, a communication interface (I/F) denoted by a reference numeral is an interface including a communication processor, an antenna, and the like. The communication I/F manages communication between a plurality of computers. Examples of the communication standard applied to the communication I/F include wireless communication standards including 5th generation mobile communication system (5G), Wi-Fi (registered trademark), Bluetooth (registered trademark), and the like.

In the following embodiments, “A and/or B” is synonymous with “at least one of A and B”. That is, “A and/or B” means only A, only B, or a combination of A and B. Furthermore, in the present specification, the same concept as “A and/or B” is applied also in a case in which three or more matters are combined and expressed by “and/or”.

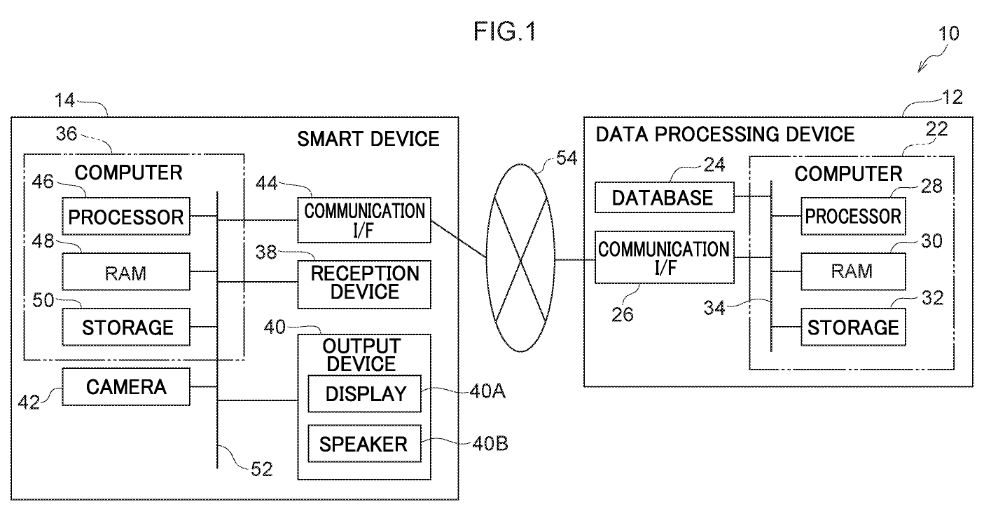

FIG. 1 illustrates an example of a configuration of a data processing system 10 according to an embodiment.

As illustrated in FIG. 1, the data processing system 10 includes a data processing device 12 and a smart device 14. An example of the data processing device 12 is a server. Examples of the smart device 14 include a smartphone, a tablet terminal, smart glasses, a headset type terminal, a personal computer, a robot, and the like. The smart device 14 is used by a user who is a learner. The smart device 14 of the present embodiment is an example of a terminal device of a user of the disclosure.

The data processing device 12 includes a computer 22, a database 24, and a communication I/F 26. The computer 22 is an example of a “computer” according to the technology of the disclosure. The computer 22 includes a processor 28, a RAM 30, and a storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a wide area network (WAN) and/or a local area network (LAN).

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. The reception device 38, the output device 40, the camera 42, and the communication I/F 44 are also connected to the bus 52.

The reception device 38 receives a user input. Examples of the reception device 38 include a touch panel, a microphone, a keyboard, a mouse, and the like. The output device 40 includes a display 40A, a speaker 40B, and the like. The output device 40 presents the data to the user by outputting the data in a user-perceptible expression (for example, voice and/or text). The camera 42 is a small digital camera on which an optical system such as a lens, a diaphragm, and a shutter and an imaging element such as a complementary metal-oxide-semiconductor (CMOS) image sensor or a charge coupled device (CCD) image sensor are mounted.

The communication I/F 44 is connected to the network 54. The communication I/F 44 and the communication I/F 26 manage the exchange of various types of information between the processor 46 and the processor 28 via the network 54.

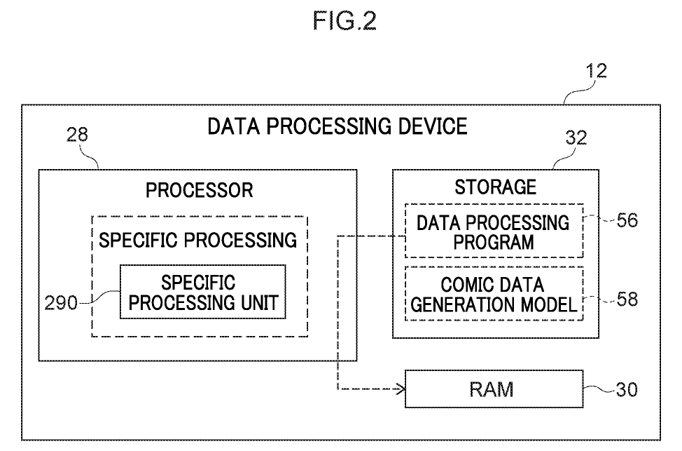

FIG. 2 illustrates an example of main functions of the data processing device 12. As illustrated in FIG. 2, in the data processing device 12, learning content generation processing is performed by the processor 28. The storage 32 stores a data processing program 56. The processor 28 reads the data processing program 56 from the storage 32 and executes the read data processing program 56 on the RAM 30. The learning content generation processing is realized by the processor 28 operating as a specific processing unit 290 according to the data processing program 56 executed on the RAM 30.

The storage 32 stores a comic data generation model 58. The comic data generation model 58 is used by the specific processing unit 290. The comic data generation model 58 may be provided in an external system such as a cloud server accessible via the network 54. The comic data generation model 58 of the embodiment is an example of a generation model of the disclosure.

The comic data generation model 58 is, for example, a generative artificial intelligence (AI).

Examples of the generative AI include ChatGPT (registered trademark) and Gemini (registered trademark). The comic data generation model 58 is obtained by causing the neural network to perform deep learning. To the comic data generation model 58, a prompt including an instruction is input, and inference data such as voice data indicating voice, text data indicating text, and image data indicating an image is input. The comic data generation model 58 infers the input inference data according to an instruction indicated by the prompt, and outputs an inference result in a data format such as voice data and text data. Here, the inference refers to, for example, analysis, classification, prediction, and/or summary.

Specifically, the comic data generation model 58 of the embodiment is used to generate comic data from a given subject and material, and at that time, is also used for parameterization of emotions of characters drawn in the material.

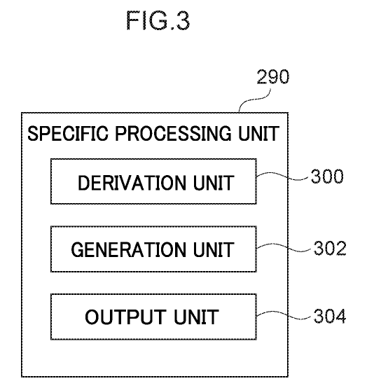

Next, a functional configuration of the specific processing unit 290 will be described with reference to FIG. 3. As illustrated in FIG. 3, the specific processing unit 290 includes a derivation unit 300, a generation unit 302, and an output unit 304.

The derivation unit 300 derives an emotion parameter representing an emotion of the character drawn in the material. In the embodiment, as an example of the emotion parameter, a mode to which a numerical value representing an emotion is applied will be described. Note that the “character” may be any character as long as an emotion appears in a facial expression or a physical characteristic. For example, the character may be, in addition to a person, an animal such as a panda or a cat, various living things regardless of whether they exist or not, an inorganic object such as a robot or a stuffed animal, or a fictitious living thing such as a monster, and is not limited.

In some embodiments, the “material” only needs to depict a portion of a character from which an emotion parameter can be derived, and the number, portion, and the like of characters depicted are not limited. Furthermore, the data may be provided in a mode in which only one material is included in one piece of data as in a single illustration, or may be provided in a mode in which a plurality of materials are included in one piece of data as in one page of a comic. Note that, in a case in which a plurality of materials are included in one piece of data, the derivation unit 300 separates each material using the comic data generation model 58 or the like.

The derivation unit 300 of the embodiment acquires a material in which a character is drawn from the database 24, and inputs the acquired material and a prompt including an instruction to quantify the emotion of the character included in the material to the comic data generation model 58. Then, the derivation unit 300 derives the parameter of the emotion of the character by acquiring the parameter of the emotion of the character output from the comic data generation model 58. In some examples, the material may be a figure or drawing where the character is drawn with a facial expression. In some examples, the material may be a digital or scanned version of the figure or drawing.

Note that a method of deriving the emotion parameter from the facial expression of the character is not limited, and a specific index for deriving the emotion parameter is not limited. In other words, a specific method of quantifying the emotion from the facial expression of the character using the comic data generation model 58 is not limited.

For example, a wheel of emotions (Plutchik’s Wheel of Emotions) devised by a psychologist Robert Plutchik may be used as an index for quantifying emotions. This wheel of emotions is a psychological model that classifies human emotions into eight basic emotions and indicates a relationship between these emotions. The eight basic emotions are joy, sadness, trust, disgust, fear, anger, surprise, and anticipation.

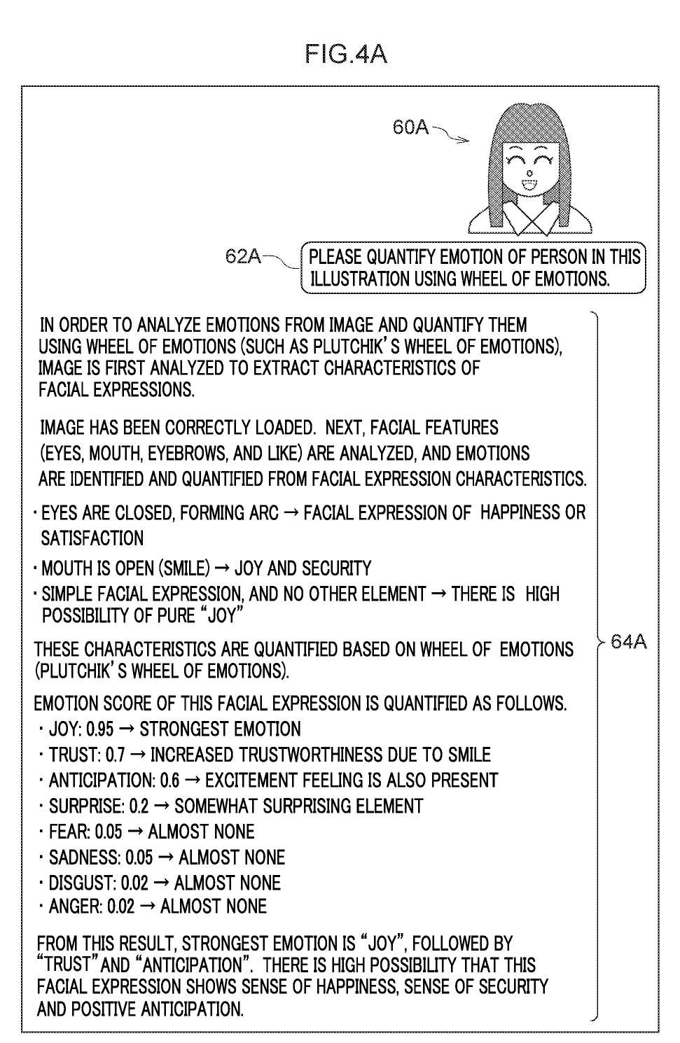

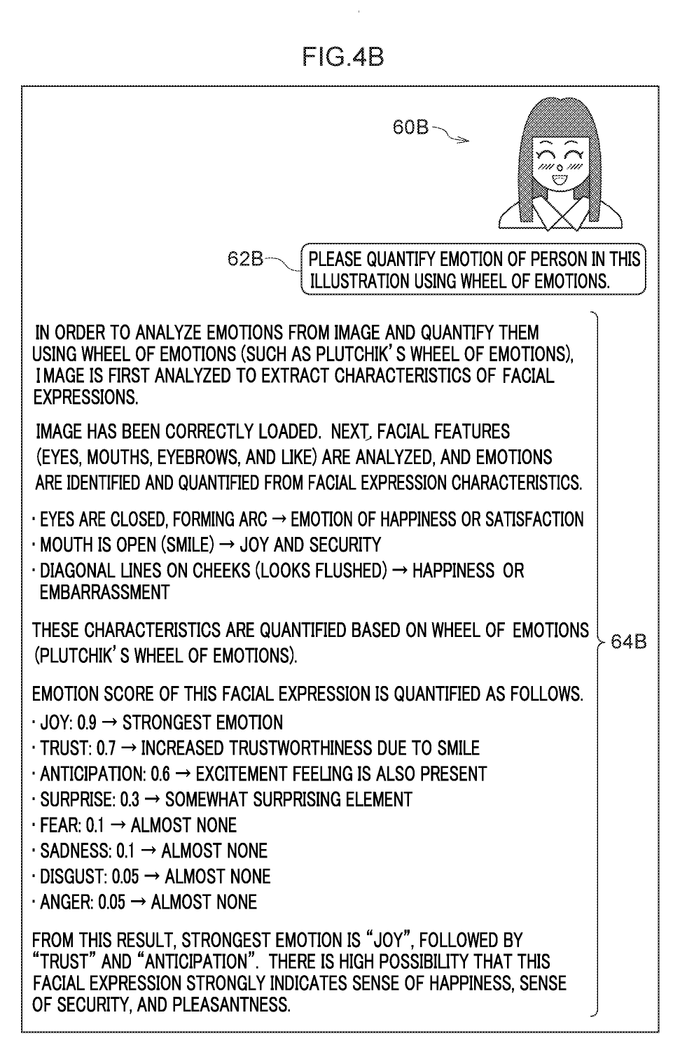

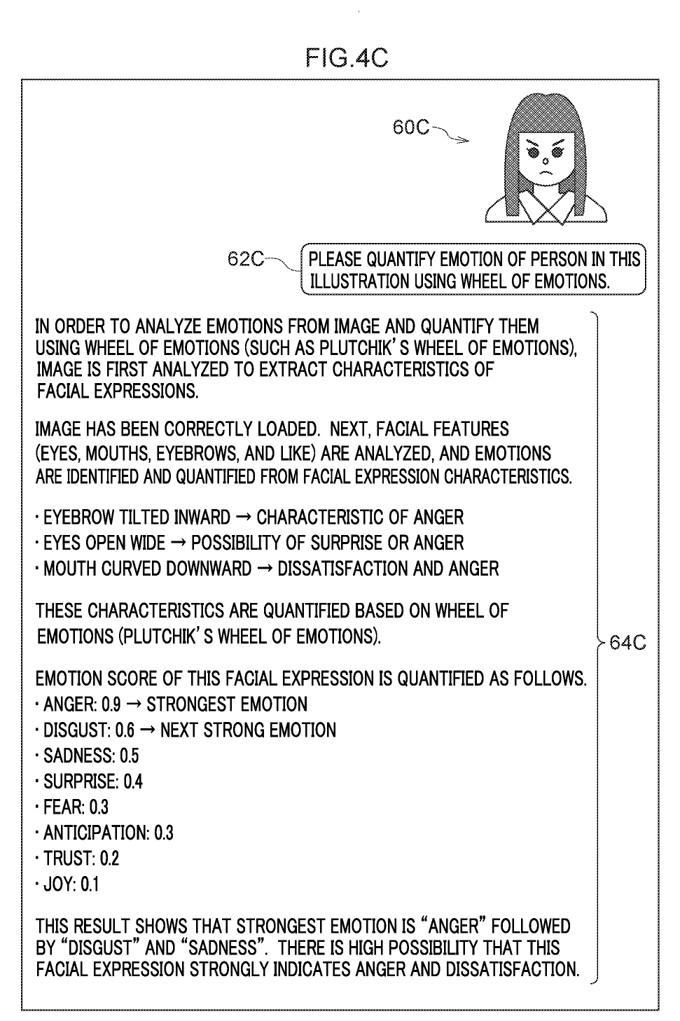

FIGS. 4A-4C illustrate examples of materials and prompts input to the comic data generation model 58 in this case. Furthermore, FIGS. 4A-4C also illustrate the output of the comic data generation model 58. Note that FIGS. 4A-4C are different in the facial expression of the character included in the material.

The character drawn on the material 60A illustrated in FIG. 4A has a smiling facial expression. In addition, the prompt 62A is an instruction to quantify the emotion using the wheel of emotions such as “please quantify the emotion of the person in this illustration using the wheel of emotions”. In some embodiments, the prompt 62A may be generated automatically, e.g. by the generation unit 302 based on historical user requests or instructions.

An output 64A illustrated in FIG. 4A is output from the comic data generation model 58 in response to the material 60A and the prompt 62A. The output 64A includes numerical values for each emotion of joy, trust, anticipation, surprise, fear, sadness, disgust, and anger. Furthermore, the output 64A illustrated in FIG. 4A also includes bases for why such a numerical value is obtained, such as “eyes are closed, forming an arc → emotion of happiness or satisfaction”, “mouth is open → joy or security”, and “simple facial expression, and no other element → there is a high possibility of pure “joy””. In some examples, a format of the output 64A may be determined based on the prompt 62A. In some examples, a format of the output 64A may be determined based on a default configuration.

In addition, the material 60B illustrated in FIG. 4B is similar to the material 60A illustrated in FIG. 4A, but is different in that the cheeks are flushed. The prompt 62B is common to the prompt 62A. As illustrated in FIG. 4B, an output 64B obtained by the material 60B and the prompt 62B is different from the output 64A illustrated in FIG. 4A. According to the material 60A, “joy” is somewhat less and “surprise” is somewhat more than those of the material 60B.

As described above, if there is a difference even in a similar facial expression, the emotion parameter output from the comic data generation model 58 differs according to the difference.

On the other hand, the material 60C illustrated in FIG. 4C is greatly different from the material 60A illustrated in FIG. 4A and the material 60B illustrated in FIG. 4B, and has an angry facial expression. The prompt 62C is common to the prompt 62A. As illustrated in FIG. 4C, an output 64C obtained by the material 60C and the prompt 62C is greatly different from the output 64A illustrated in FIG. 4A and the output 64B illustrated in FIG. 4B.

As described above, the derivation unit 300 can derive the emotion parameter using the wheel of emotions as an index by using the comic data generation model 58.

Furthermore, for example, a visual characteristic of a character drawn on a material may be used as an index for quantifying emotions. In other words, there may be an aspect in which the comic data generation model 58 derives the emotion parameter by evaluating the state of the physical parts on the basis of the visual characteristic of the character. In this case, the comic data generation model 58 extracts the shape of the eyebrow, the shape of the eye, the shape of the mouth, the contour of the face, and the like as the visual characteristics of the emotion, associates each extracted characteristic with a predetermined emotion category, and sets the score. Then, the comic data generation model 58 adjusts each score and determines the final numerical value in consideration of the balance of the entire facial expression.

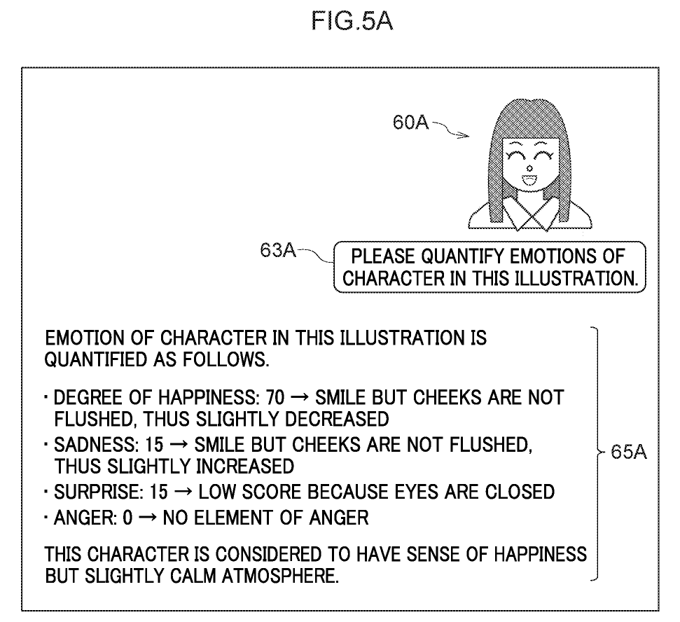

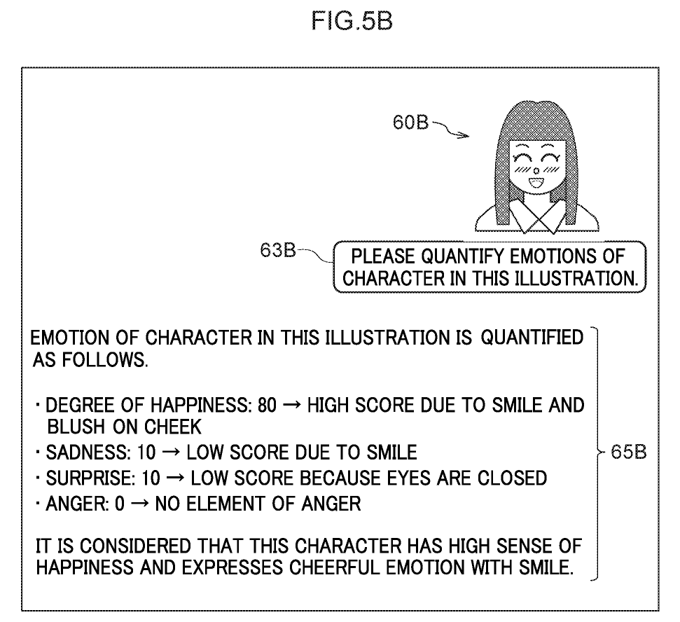

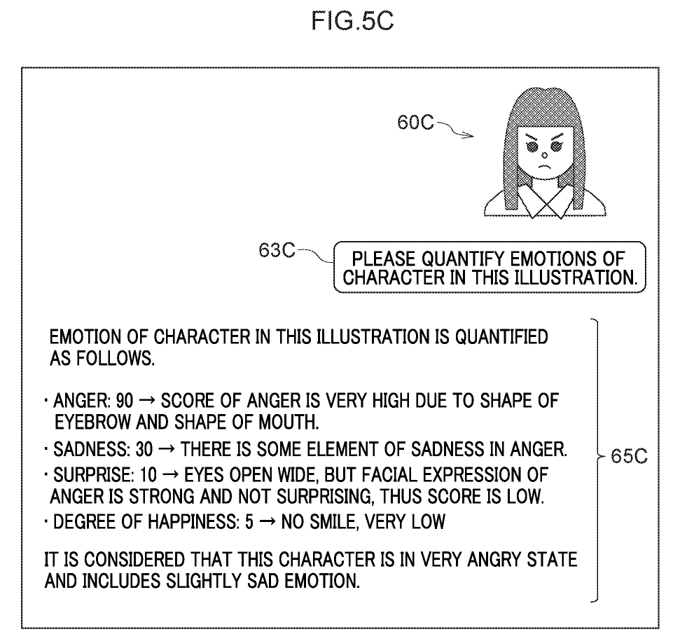

FIGS. 5A-5C illustrate an example of a material and a prompt to be input to the comic data generation model 58 when evaluating a state of physical parts on the basis of a visual characteristic of a character to quantify an emotion of the character included in the material. Furthermore, FIGS. 5A-5C also illustrate the output of the comic data generation model 58.

As illustrated in FIGS. 5A-5C, the prompts 63A to 63C in this case are instructions to “please quantify emotions of characters in this illustration”. As can be seen from the comparison between the output 64A of FIG. 4A and the output 65A of FIG. 5A, the comparison between the output 64B of FIG. 4B and the output 65B of FIG. 5B, and the comparison between the output 64C of FIG. 4C and the output 65C of FIG. 5C, the obtained emotion parameters show substantially the same tendency although specific numerical values and the like are different.

As described above, the derivation unit 300 can derive the emotion parameter using the visual characteristic of the character drawn in the material by using the comic data generation model 58.

Note that, in the above-described example, since the materials 60A to 60C are the face portions of the character, the emotion parameters are derived on the basis of the facial expression of the face. However, for example, the emotion parameters may also be derived on the basis of characteristics of other parts of the character, such as a shoulder being hunched or a fist being clenched. Furthermore, in a case in which the material includes an utterance of a character, the emotion parameter may be derived on the basis of the utterance.

Furthermore, as can be seen by comparing FIGS. 4A-4C with FIGS. 5A-5C, when using the comic data generation model 58, specific content such as an instruction input to a prompt affects output from the comic data generation model 58. Therefore, in a case in which the emotion parameter is derived using the comic data generation model 58, it is preferable that the specific content of the prompt to be input together with the material is the same. In some examples, the specific content of the prompt may be determined automatically based on the corresponding material.

The generation unit 302 generates dialogue on the basis of a story according to the subject, and places the dialogue and the characters in each panel of a panel layout using the comic data generation model 58 on the basis of a parameter to generate comic data to be displayed according to the panel layout.

First, the generation unit 302 acquires a subject. Note that a method by which the generation unit 302 acquires the subject is not limited. For example, the generation unit 302 may acquire a subject specified in the smart device 14. Furthermore, for example, the generation unit 302 may acquire a subject from an external device (not illustrated).

Furthermore, as an example, the generation unit 302 of the embodiment generates a story of a comic for explaining a subject used to educate the user (learner), and dialogue of characters of the comic, using the comic data generation model 58. As a specific example, the generation unit 302 generates a prompt including an instruction for generating a story and dialogue of a comic for the learner to learn the subject, and inputs the generated prompt to the comic data generation model 58. In some embodiments, the generation unit 302 may generate the prompt based on a subject input by the user or another user (e.g. an educator). Hereinafter, for convenience of description, a case in which Internet Protocol version 6 (IPv6) for the information technology (IT) passport test is used as a subject will be described as the specific example.

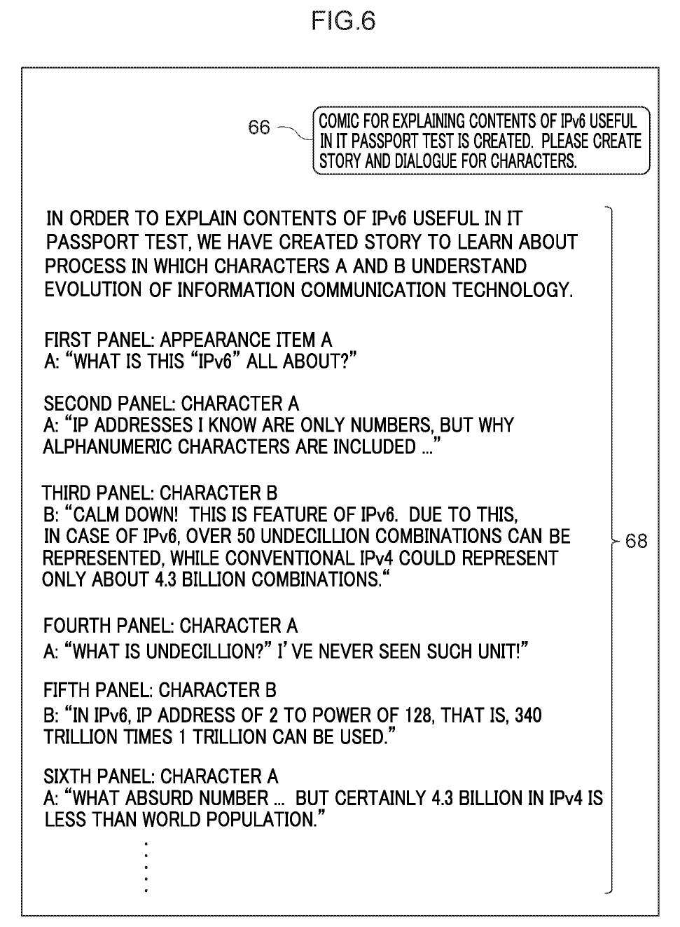

For example, as illustrated in FIG. 6, the generation unit 302 generates a prompt 66 “Comic for explaining the contents of IPv6 useful in the IT passport test will be created. Please create a story and dialogue of characters.” and inputs the prompt to the comic data generation model 58. Note that an example of the prompt in this case is not limited to the prompt 66, and may include, for example, information regarding characters, volume of comic, information regarding learners, and the like. Examples of the information regarding the characters include the number of characters, characteristics of characters such as sex and age, and the like. Examples of the volume of the comic include the total number of pages, the number of panels per page, and the like. Furthermore, examples of the information regarding the user include the age of the learner, the preference of the learner, and the like.

FIG. 6 illustrates an example of an output 68 output from the comic data generation model 58 in response to the input prompt 66. The output 68 includes a dialogue of characters A and B generated for each panel of the panel layout on the basis of a story of learning a process of understanding the evolution of the information communication technology. In some examples, the characters A and B can be determined based on information regarding characters in the prompt. In some embodiments, the characters A and B may be selected from a character pool including characters whose emotion parameters and corresponding comic materials have been previously generated and stored. In some embodiments, one or more of the characters A and B (e.g. character B) may be a new character without emotion parameter data or an existing character whose comic materials and emotion parameters have not been fully obtained or generated. In some examples, a comic material having an emotion parameter of such character B may be generated based on a reference character’s material having the same emotion parameter, e.g. by transferring a facial expression corresponding to the emotion parameter from the reference character to the character B.

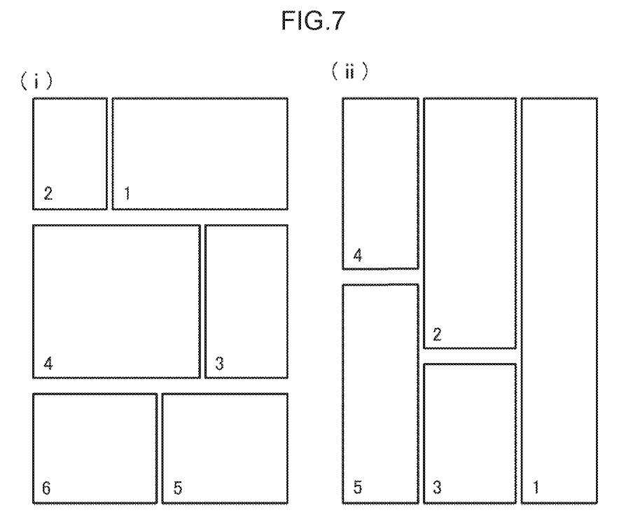

Next, the generation unit 302 of the embodiment determines a type of panel layout. As an example, after causing the comic data generation model 58 to output the output 68, the generation unit 302 of the embodiment subsequently generates a prompt including an instruction for determining panel layout and causes the prompt to be input to the comic data generation model 58. The instruction included in the prompt in this case includes, for example, an instruction for giving a name of a type of panel layout, such as a stripe type (horizontal division), a block type (lattice type), and a free layout (irregular type), and causing the model to determine any one of them. Furthermore, examples of the instruction include an instruction for causing the example of panel layout as illustrated in FIG. 7 to be input to the comic data generation model 58 and causing the model to determine any of the input examples of panel layout. In the example illustrated in FIG. 7, (i) is an example of the stripe type, and (ii) is an example of the irregular type. Furthermore, the order of each panel may also be indicated, such as the number in each panel in the example illustrated in FIG. 7. In some examples, the prompt including the instruction for determining the panel layout may be automatically generated by the generation unit 302 based on a subject of the comic, the characters in the comic, and/or other content or characteristics of the comic. In some embodiments, the prompt including the instruction for determining the panel layout may be generated and input to the comic data generation model 58 as part of the prompt 66.

When a prompt including an instruction for determining panel layout is input, the comic data generation model 58 outputs a type of panel layout for allocating dialogue of characters.

Furthermore, the generation unit 302 of the embodiment places dialogue and characters in each panel of the determined panel layout, using the comic data generation model 58, on the basis of the emotion parameter.

As an example, the generation unit 302 of the embodiment derives an emotion parameter of an emotion that can be read from each line of dialogue using the comic data generation model 58. Note that the index for deriving the emotion parameter from the dialogue is not limited to a specific index used when the derivation unit 300 derives the emotion parameter of the character drawn in the material. Furthermore, the generation unit 302 places each line of dialogue into panel layout using the comic data generation model 58. Specifically, the generation unit 302 generates a prompt including an instruction for deriving the emotion parameter from each line of dialogue and inputs the prompt to the comic data generation model 58. Subsequently, the generation unit 302 generates a prompt including an instruction for placing each line of dialogue in each panel of the panel layout, and inputs the prompt to the comic data generation model 58. In some examples, the generation unit 302 may input all of these prompts together as a combined prompt to the comic data generation model 58, for the comic data generation model 58 to automatically generate all outputs without stopping.

When a prompt including an instruction for deriving the emotion parameter from each line of dialogue is input, the comic data generation model 58 outputs the emotion parameter for each line of dialogue. Furthermore, when a prompt including an instruction for placing each line of dialogue in each panel of the panel layout is input, the comic data generation model 58 outputs a placement result of placing the dialogue in each panel.

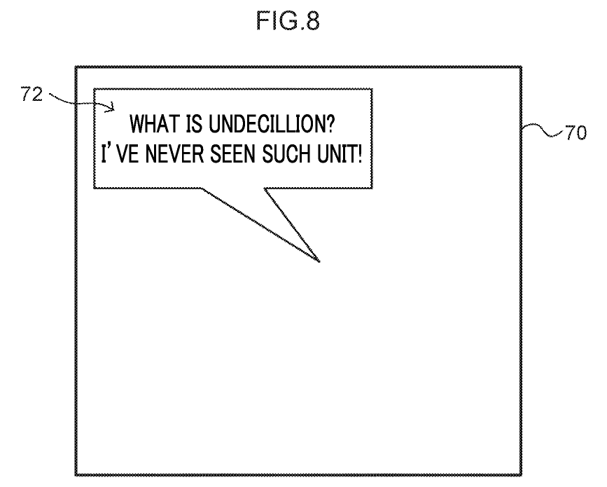

As an example of the placement result, FIG. 8 illustrates an example of a state in which dialogue 72 is placed in the panel 70. FIG. 8 is an example of a state in which dialogue for “What is Undecillion? I’ve never seen such a unit!” of the character A in the fourth panel included in the output 68 illustrated in FIG. 6 is placed in the fourth panel of the panel layout illustrated in (i) of FIG. 7.

Furthermore, the generation unit 302 refers to the emotion parameter derived by the derivation unit 300 for a character drawn in the material, and places the character from which the emotion parameter closest to the emotion parameter of the dialogue placed in each panel is derived in each panel so as to correspond to the dialogue. Specifically, the generation unit 302 selects the character closest to the emotion parameter of the dialogue of each panel from the material from which the emotion parameter is derived, generates a prompt including an instruction to place the character in each panel, and inputs the prompt to the comic data generation model 58. In some examples, for each character in a character pool, a similarity score may be determined to represent a similarity or closeness between the character and the emotion parameter in each panel. A total similarity score may be generated for each character based on a weighted combination of all of the character’s similarity scores regarding different emotion parameters in all panels of the comic. The generation unit 302 may select the character whose total similarity score is highest among all characters.

When a prompt including an instruction for placing a character relative to the dialogue of each panel on the basis of the emotion parameter is input, the comic data generation model 58 outputs a placement result in which the dialogue and the character are placed in each panel of the panel layout. In some examples, the panel layout can be adaptively updated based on the user’s interaction. For example, if the user zooms in frequently a particular type of panels with characters or emotions falling into a particular group, those panels can be changed to a larger size, a brighter color, a top location of a webpage, or be highlighted in another manner. In some cases, the character in the comic can be updated with more emotions matching the user’s interest, which may be shown by e.g. clicking, viewing, zooming, etc.

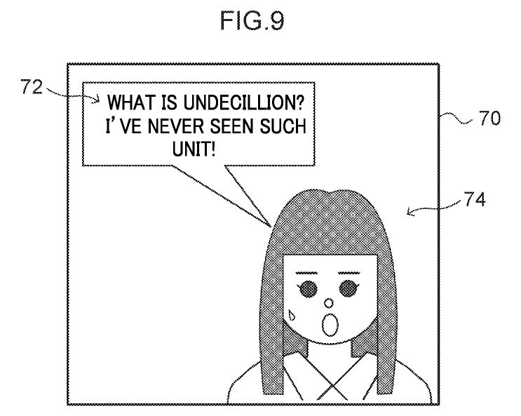

As an example of the placement result, FIG. 9 illustrates an example of a state in which a character 74 is placed as a character in a panel 70 in which the dialogue 72 illustrated in FIG. 7 is placed. The emotion parameter of the dialogue 72 derived by the generation unit 302 using the comic data generation model 58 is “surprise: 90, confusion: 80”. As the character from which the emotion parameter closest to this emotion parameter is derived, the character 74 whose emotion parameter is “surprise: 90, confusion: 70” is placed in the panel 70 by the generation unit 302 in correspondence with the dialogue 72, thereby achieving the state illustrated in FIG. 9.

The generation unit 302 acquires the placement result output from the comic data generation model 58 as comic data.

As described above, according to the generation unit 302, data (comic data) of the comic for explaining a given subject is generated using a character drawn on a material as a character.

The output unit 304 outputs the comic data generated by the generation unit 302 to the smart device 14.

In the smart device 14, a comic corresponding to the comic data input from the data processing device 12 is displayed on the display 40A. As a result, the learner who is the user of the smart device 14 can learn the subject by reading the comic. In some examples, the learner may interact with the comic, by e.g. asking questions, requesting a change of a character, requesting a change of the dialogue content, requesting a change of the panel layout, etc. In some embodiments, based on user interaction or user feedback, the system can automatically fine-tune or re-train the comic data generation model 58, and/or automatically adjust the prompt generation logic for generating new prompts.

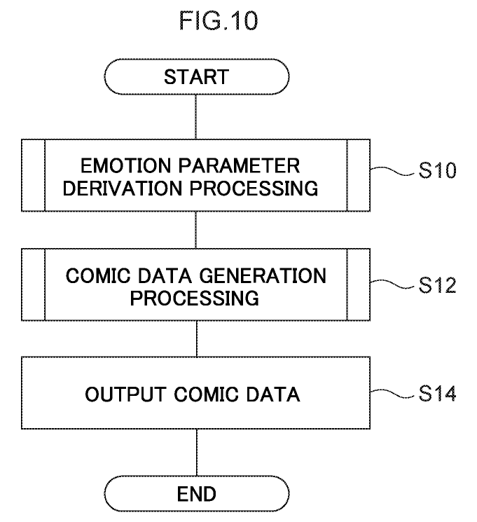

Next, an example of a flow of learning content generation processing for generating comic data as learning content will be described with reference to FIGS. 10-12.

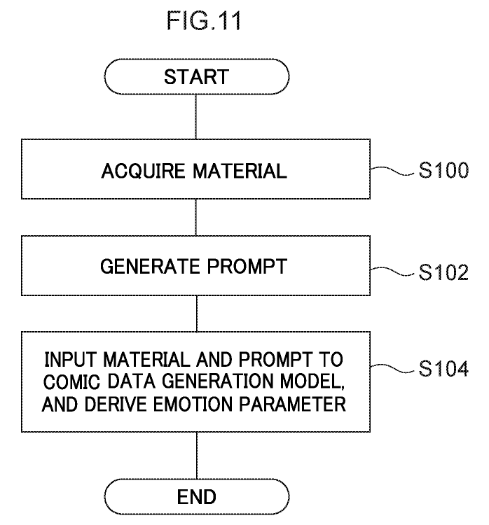

In step S10 of FIG. 10, the derivation unit 300 executes the emotion parameter derivation processing to derive the emotion parameter representing the emotion of the character drawn in the material. An example of the emotion parameter derivation processing will be described with reference to FIG. 11. FIG. 11 illustrates an example of a flow of emotion parameter derivation processing.

In step S100 of FIG. 11, as described above, the generation unit 302 acquires the material in which the character is drawn from the database 24.

In the next step S102, the derivation unit 300 generates a prompt including an instruction to quantify the emotion of the character included in the material as described above.

In the next step S104, as described above, the derivation unit 300 inputs the material acquired in step S100 and the prompt generated in step S102 to the comic data generation model 58, and acquires the output of the comic data generation model 58 to derive the emotion parameter. When the process of step S104 ends, the emotion parameter derivation processing ends.

Note that, in step S10 of the learning content generation processing, the derivation unit 300 derives the emotion parameter of the drawn character for a plurality of materials. For example, the derivation unit 300 may repeat the emotion parameter derivation processing illustrated in FIG. 11. Furthermore, for example, the derivation unit 300 may repeat, for each material, the process of acquiring a plurality of materials in step S100 and inputting the materials and the prompt to the comic data generation model 58 to derive the emotion parameter in step S104.

When the emotion parameter of the character of the material is derived by the derivation unit 300 in this manner, the process of step S10 illustrated in FIG. 10 ends, and the process proceeds to step S12.

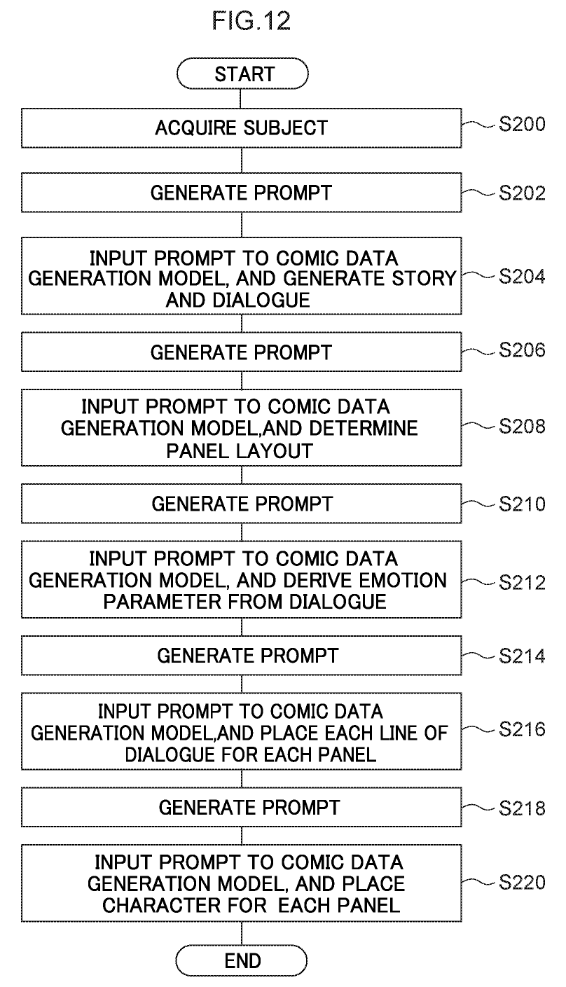

In step S12, the generation unit 302 executes the comic data generation processing, and generates the comic data for explaining the subject on the basis of the emotion parameter. An example of the comic data generation processing will be described with reference to FIG. 12. FIG. 12 illustrates an example of a flow of the comic data generation processing.

In step S200 of FIG. 12, the generation unit 302 acquires a subject for learning as described above.

In the next step S202, the generation unit 302 generates a prompt including an instruction to generate a story and dialogue of a comic for the learner to study the subject, as described above.

In the next step S204, as described above, the generation unit 302 inputs the prompt generated in step S202 to the comic data generation model 58, and acquires the output of the comic data generation model 58, thereby generating the story and the dialogue.

In the next step S206, as described above, the generation unit 302 generates a prompt including an instruction for determining the panel layout.

In the next step S208, as described above, the generation unit 302 inputs the prompt generated in step S206 to the comic data generation model 58, and acquires the output of the comic data generation model 58, thereby determining the panel layout.

In the next step S210, the generation unit 302 generates a prompt including an instruction for deriving the emotion parameter from each line of dialogue as described above.

In the next step S212, as described above, the generation unit 302 derives the emotion parameter from the dialogue by causing the prompt generated in step S210 to be input to the comic data generation model 58 and acquiring the output of the comic data generation model 58.

In the next step S214, as described above, the generation unit 302 generates a prompt including an instruction for placing each line of dialogue in each panel of the panel layout.

In the next step S216, as described above, the generation unit 302 inputs the prompt generated in step S214 to the comic data generation model 58, and acquires the output of the comic data generation model 58, thereby placing each line of dialogue in each panel.

In the next step S218, as described above, the generation unit 302 selects the character closest to the emotion parameter of the dialogue of each panel from the material from which the emotion parameter is derived, and generates a prompt including an instruction to place the character in each panel.

In the next step S220, as described above, the generation unit 302 inputs the prompt generated in step S218 to the comic data generation model 58, and acquires the output of the comic data generation model 58, thereby placing characters in each panel. When the process of step S220 ends, the comic data generation processing ends.

When the comic data is generated by the generation unit 302 in this manner, the process of step S12 illustrated in FIG. 10 ends, and the process proceeds to step S14.

In step S14, the output unit 304 outputs the comic data generated by the comic data generation processing in step S12 to the smart device 14. When the processing of step S14 ends, the learning content generation processing illustrated in FIG. 10 ends.

As described above, according to the learning content generation processing of the embodiment, it is possible to generate the comic data for explaining the subject as the learning content. The generated comic data can be provided to the user who is a learner. Since the generated comic data is a comic, the interest of the learner can be easily attracted, and the content can be easily understood and made easier to remember. Furthermore, barriers to learning can be lowered.

Note that, as the above-described learning content generation processing, a mode in which the emotion parameter derivation processing and the comic data generation processing are executed as a series of processing has been described, but a mode in which each processing is executed separately, that is, at different timings may be used. For example, in a case in which the comic data generation model 58 can refer to the database, the material derived by the emotion parameter derivation processing and the emotion parameter may be stored in the database in association with each other, and the database may be referred to in the comic data generation processing.

Furthermore, in the comic data generation processing, the specific order of the processing of generating the story, the processing of generating the dialogue, the processing of determining panel layout, the processing of deriving the emotion parameter from the dialogue, the processing of placing the dialogue in the panels, and the processing of placing the characters in the panels is not limited to the embodiment, and can be changed as appropriate. In addition, the instruction included in one prompt may be an instruction for executing a plurality of processes among these. For example, unlike the above embodiment, one prompt may include an instruction to collectively execute processing of generating a story, processing of generating dialogue, and processing of deriving an emotion parameter from the dialogue.

Furthermore, the data processing device 12 may acquire feedback on the comic from the smart device 14. Examples of the feedback include the impression of the learner on the comic, the degree of understanding of the learner on the subject, and the like. Furthermore, in a case in which the learner’s impression on the character of the comic is obtained as the feedback, a usage rate of the material including the corresponding character may be adjusted according to the impression. Furthermore, a profit obtained by providing the comic data may be returned to the providing source of the material according to the usage rate.

Furthermore, in the above description, a mode in which the data processing device 12 generates comic data for a learner to learn a subject has been described, but any mode may be used as long as the mode generates comic data for a certain subject. In other words, the comic data generated by the data processing device 12 is not limited to the comic data of the comic used for learning.

Although the system according to the disclosure has been mainly described in terms of the functions of the data processing device 12, the system according to the disclosure is not necessarily implemented in a server. The system according to the disclosure may be implemented as a general information processing system. The disclosure may be implemented as, for example, a software program operating on a personal computer or an application operating on a smartphone or the like. The method according to the disclosure may be provided to a user in a software as a service (SaaS) format.

In the above embodiment, the embodiment in which the specific processing is performed by one computer 22 has been described, but the technology of the disclosure is not limited thereto, and the distributed processing for the specific processing by a plurality of computers including the computer 22 may be performed. For example, the comic data generation model 58 may be provided in an external device of the data processing device 12, and the external device may generate data according to input data.

In the above embodiment, the embodiment in which the data processing program 56 is stored in the storage 32 has been described, but the technology of the disclosure is not limited thereto. For example, the data processing program 56 may be stored in a portable computer-readable non-transitory storage medium such as a universal serial bus (USB) memory. The data processing program 56 stored in the non-transitory storage medium is installed in the computer 22 of the data processing device 12. The processor 28 executes specific processing according to the data processing program 56.

In addition, the data processing program 56 may be stored in a storage device such as a server connected to the data processing device 12 via the network 54, and the data processing program 56 may be downloaded and installed in the computer 22 in response to a request from the data processing device 12.

Note that it is not necessary to store all of the data processing program 56 in the storage device such as a server connected to the data processing device 12 via the network 54 or to store all of the data processing program 56 in the storage 32, and a part of the data processing program 56 may be stored.

The following various processors can be used as hardware resources for executing the specific processing. Examples of the processor include a CPU which is a general-purpose processor functioning as a hardware resource that executes specific processing by executing software, that is, a program. In addition, examples of the processor include a dedicated electric circuit which is a processor having a circuit configuration exclusively designed for executing specific processing such as a field-programmable gate array (FPGA), a programmable logic device (PLD), or an application specific integrated circuit (ASIC). A memory is built in or connected to any processor, and any processor executes specific processing by using the memory.

The hardware resource that executes the specific processing may be configured by one of these various processors, or may be configured by a combination of two or more processors of the same type or different types (for example, a combination of a plurality of FPGAs or a combination of a CPU and an FPGA). The hardware resource that executes the specific processing may be one processor.

As an example of the configuration including one processor, first, there is a mode in which one processor is configured by a combination of one or more CPUs and software, and the processor functions as a hardware resource that executes specific processing. Second, as represented by a system-on-a-chip (SoC) or the like, there is a form of using a processor that realizes a function of the entire system including a plurality of hardware resources for executing specific processing by one IC chip. In this manner, the specific processing is realized by using one or more of the above-described various processors as hardware resources.

Furthermore, more specifically, an electric circuit in which circuit elements such as semiconductor elements are combined can be used as a hardware structure of these various processors. In addition, the above-described specific processing is merely an example. Therefore, it is needless to say that unnecessary steps may be deleted, new steps may be added, or the processing order may be changed within a range not departing from the gist.

The contents described and illustrated above are detailed descriptions of parts according to the technology of the disclosure, and are merely examples of the technology of the disclosure. For example, the above description regarding the configuration, function, operation, and effect is a description regarding an example of the configuration, function, operation, and effect of the portion according to the technology of the disclosure. Therefore, it is needless to say that unnecessary portions may be deleted, new elements may be added, or replacement may be made with respect to the above described and illustrated contents without departing from the gist of the technology of the disclosure. Furthermore, in order to avoid complication and to facilitate understanding of the portion according to the technology of the disclosure, in the description content and the illustrated content described above, description regarding technical common sense or the like that does not require any particular description in enabling implementation of the technology of the disclosure is omitted.

All documents, patent applications, and technical standards described in this specification are incorporated herein by reference to the same extent as if each individual document, patent application, and technical standard were specifically and individually indicated to be incorporated by reference.

With regard to the embodiments described above, the following Supplementary notes are further disclosed.

### Supplementary note 1

A data processing device including:

a derivation unit that derives an emotion parameter representing an emotion of a character drawn in a material; and

a generation unit that generates dialogue on the basis of a story according to a subject, and generates comic data by placing the dialogue and the character in each panel of a panel layout by using a generation model on the basis of the emotion parameter.

### Supplementary note 2

The data processing device according to Supplementary note 1, in which

the emotion parameter is obtained by quantifying the emotion on the basis of a wheel of emotions devised by Robert Plutchik.

### Supplementary note 3

The data processing device according to Supplementary note 1, in which

the emotion parameter is obtained by quantifying the emotion by evaluating a state of physical parts on the basis of a visual characteristic of the character.

### Supplementary note 4

The data processing device according to any one of Supplementary notes 1 to 3, in which

the derivation unit derives the emotion parameter also on the basis of an utterance of the character in a case in which the material includes the utterance of the character.

### Supplementary note 5

The data processing device according to Supplementary note 1, in which

the generation unit associates the character with each line of dialogue on the basis of the emotion parameter.

### Supplementary note 6

The data processing device according to any one of Supplementary notes 1 to 5, further including

an output unit that outputs the comic data to a terminal device of a user.

### Supplementary note 7

A data processing method for causing a computer to execute processing including:

deriving an emotion parameter representing an emotion of a character drawn in a material;

generating dialogue on the basis of a story according to a subject; and

generating comic data by placing the dialogue and the character in each panel of a panel layout by using a generation model on the basis of the emotion parameter.

### Supplementary note 8

A program for causing a computer to execute processing including:

deriving an emotion parameter representing an emotion of a character drawn in a material;

generating dialogue on the basis of a story according to a subject; and

generating comic data by placing the dialogue and the character in each panel of a panel layout by using a generation model on the basis of the emotion parameter.

What is claimed is:

1. A data processing device comprising a processor,
wherein the processor is configured to:
derive an emotion parameter representing an emotion of a character drawn in a material;
generate a dialogue on the basis of a story according to a subject; and
generate comic data by placing the dialogue and the character in each panel of a panel layout by using a generation model on the basis of the emotion parameter.

2. The data processing device according to claim 1, wherein
the emotion parameter is obtained by quantifying the emotion on the basis of a wheel of emotions devised by Robert Plutchik.

3. The data processing device according to claim 1, wherein
the emotion parameter is obtained by quantifying the emotion by evaluating a state of physical parts on the basis of a visual characteristic of the character.

4. The data processing device according to claim 1, wherein
the processor derives the emotion parameter also on the basis of an utterance of the character in a case in which the material includes the utterance of the character.

5. The data processing device according to claim 1, wherein
the processor associates the character with each line of dialogue on the basis of the emotion parameter.

6. The data processing device according to claim 1, wherein
the processor is configured to output the comic data to a terminal device of a user.

7. A data processing method for causing a computer to execute processing comprising:
deriving an emotion parameter representing an emotion of a character drawn in a material;
generating a dialogue on the basis of a story according to a subject; and
generating comic data by placing the dialogue and the character in each panel of a panel layout by using a generation model on the basis of the emotion parameter.

8. A non-transitory computer-readable storage medium storing a program for causing a computer to execute processing comprising:
deriving an emotion parameter representing an emotion of a character drawn in a material;
generating a dialogue on the basis of a story according to a subject; and
generating comic data by placing the dialogue and the character in each panel of a panel layout by using a generation model on the basis of the emotion parameter.
